(19) United States
(12) Patent Application Publication
(10) Pub. No.: US 2014/0375339 A1
(43) Pub. Date: Dec. 25, 2014

(54) FUEL PROPERTY SENSOR

(71) Applicant: DENSO CORPORATION, Kariya-city (JP)

(72) Inventors: Dai Osada, Kariya-city (JP); Hirotsugu Ishino, Toyokawa-city (JP)

(21) Appl. No.: 14/301,525

(22) Filed: Jun. 11, 2014

(30) Foreign Application Priority Data
Jun. 24, 2013 (JP) 2013-131718

(51) Int. Cl. G01N 27/22

(52) U.S. Cl. CPC G01N 27/22
USPC 324/663

(57) ABSTRACT

A fuel pipe is mounted to a vehicle body. A detection electrode is immersed in fuel, which flows through the fuel pipe. A grounding electrode is in a tubular member and is located outside the detection electrode. An affixing member affixes the fuel pipe and the grounding electrode in a state where the fuel pipe and the grounding electrode are electrically isolated from each other. A detection circuit detects a capacitance between the detection electrode and the grounding electrode according to a specific inductive capacity of fuel, which flows between the detection electrode and the grounding electrode. A conductive shield portion extends from an end of the grounding electrode and extends between the detection electrode and the fuel pipe. The end of the grounding electrode is immersed in fuel, which flows through the fuel pipe.

### CROSS REFERENCE TO RELATED APPLICATION

This application is based on reference Japanese Patent Application No. 2013-131718 filed on Jun. 24, 2013, the disclosure of which is incorporated herein by reference.

### TECHNICAL FIELD

The present disclosure relates to a fuel property sensor configured to detect a property of fuel.

### BACKGROUND

Conventionally, a known fuel property sensor is configured to detect a property of fuel, such as a concentration of ethanol contained in fuel for an internal combustion engine. Patent Document 1 discloses a fuel property sensor including a fuel pipe, which is in a bottomed tubular shape. The fuel pipe accommodates a detection electrode and a grounding electrode. The detection electrode is equipped inside the tubular grounding electrode. The detection circuit is configured to detect a capacitance, which corresponds to a specific inductive capacity of fuel residing between the detection electrode and the grounding electrode. The detection circuit sends a signal, which represents the detected capacitance, to a circuit network of the vehicle through a wire harness. An electronic control unit (ECU) is equipped to the circuit network of the vehicle. The ECU controls an operation parameter, such as a fuel injection quantity, ignition timing, and/or the like, according to the property of fuel detected with the fuel property sensor.

### Patent Document 1

Publication of unexamined Japanese patent application No. 2013-83554

The fuel property sensor disclosed in Patent Document 1 includes a lid member, which covers an opening of the fuel pipe, which is in the bottomed tubular shape. The lid member electrically connects the fuel pipe with the grounding electrode. Therefore, the fuel pipe and the grounding electrode are at the same electric potential. For example, it may be assumable to omit the lid member from the fuel property sensor disclosed in Patent Document 1. In this case, the omission of the lid member may exert an influence on a detection accuracy of the fuel property sensor.

### SUMMARY

It is an object of the present disclosure to produce a fuel property sensor having an enhanced detection accuracy.

As follows, an assumable configuration will be studied. For example, the lid member may be omitted from the fuel property sensor disclosed in Patent Document 1. In this case, the fuel pipe and the grounding electrode may be fixed by using a component formed of an insulative material, such as resin. The fuel pipe is mounted to a vehicle body. In general, the vehicle body may be electrically connected to a ground of a battery of the vehicle. The grounding electrode may be electrically connected to the ground of the battery through a wire harness and a circuit network of the vehicle. The wire harness is connected to a detection circuit. In this configuration, a capacitive coupling may occur between the fuel pipe and the detection electrode. In addition, a capacitive coupling may occur between the detection electrode and the grounding electrode. Consequently, a closed circuit may be formed among the capacitive coupling between the fuel pipe and the detection electrode, the capacitive coupling between the detection electrode and the grounding electrode, the circuit network of the vehicle, the battery, and the vehicle body on which the fuel pipe was mounted. It is noted that, the circuit network of the vehicle has a specific impedance in the closed circuit. Therefore, the grounding electrode and the fuel pipe are not necessarily at the same electric potential. It is further assumable that an electromagnetic wave may occur due to a disturbance to exert an influence on the wire harness connected to the detection circuit. In this case, the electromagnetic wave may induce an electromagnetic induction noise. Consequently, capacitive coupling may occur between the detection electrode and the fuel pipe. Thus, an alternating current may flow into the closed circuit. The alternating current may exert an influence on the electric potential of the detection electrode, which is detected with the detection circuit. Therefore, it is concerned about decrease in a detection accuracy of the fuel property sensor.

According to an aspect of the present disclosure, a fuel property sensor comprises a fuel pipe configured to be mounted to a vehicle body. The fuel property sensor further comprises a detection electrode configured to be immersed in fuel, which flows through the fuel pipe. The fuel property sensor further comprises a grounding electrode being in a tubular shape and located outside the detection electrode. The fuel property sensor further comprises an affixing member configured to affix the fuel pipe and the grounding electrode in a state where the fuel pipe and the grounding electrode are electrically isolated from each other. The fuel property sensor further comprises a detection circuit configured to detect a capacitance between the detection electrode and the grounding electrode according to a specific inductive capacity of fuel, which flows between the detection electrode and the grounding electrode. The fuel property sensor further comprises a shield portion being electrically conductive, the shield portion extending from an end of the grounding electrode and extending between the detection electrode and the fuel pipe. The end of the grounding electrode is configured to be immersed in fuel, which flows through the fuel pipe.

### BRIEF DESCRIPTION OF THE DRAWINGS

The above and other objects, features and advantages of the present invention will become more apparent from the following detailed description made with reference to the accompanying drawings. In the drawings:

FIG. 1 is a perspective view showing a fuel property sensor according to a first embodiment of the present disclosure;

FIG. 2 is a sectional view showing the fuel property sensor according to the first embodiment of the present disclosure;

FIG. 3 is a sectional view taken along a line III-III in FIG. 2;

FIG. 4 is a sectional view showing a fuel property sensor according to a second embodiment of the present disclosure;

FIG. 5 is a sectional view taken along a line V-V in FIG. 4;

FIG. 6 is a graph showing a relation between a detection error and a width of a shield portion of the fuel property sensor;

FIG. 7 is a sectional view showing a fuel property sensor according to a third embodiment of the present disclosure;

FIG. 8 is a sectional view taken along a line VIII-VIII in FIG. 7; and

FIG. 9 is a sectional view showing a fuel property sensor according to a fourth embodiment of the present disclosure.

### DETAILED DESCRIPTION

As follows, embodiments of the present disclosure will be described with reference to drawings.

### First Embodiment

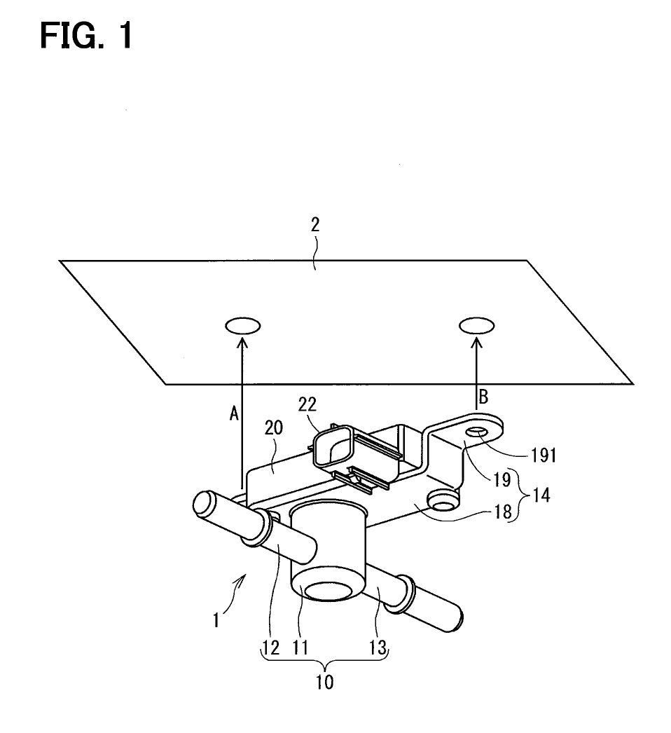

A first embodiment of the present disclosure will be described with reference to FIGS. 1 to 3. A fuel property sensor 1 according to the present embodiment is equipped to a fueling system, which connects a fuel tank with an injector of a vehicle. The fuel property sensor 1 is configured to detect a concentration of ethanol contained in fuel. The fuel property sensor 1 includes a fuel pipe 10, an affixing member 20, a detection circuit 30, a detection electrode 40, a grounding electrode 50, a shield portion 60, and/or the like.

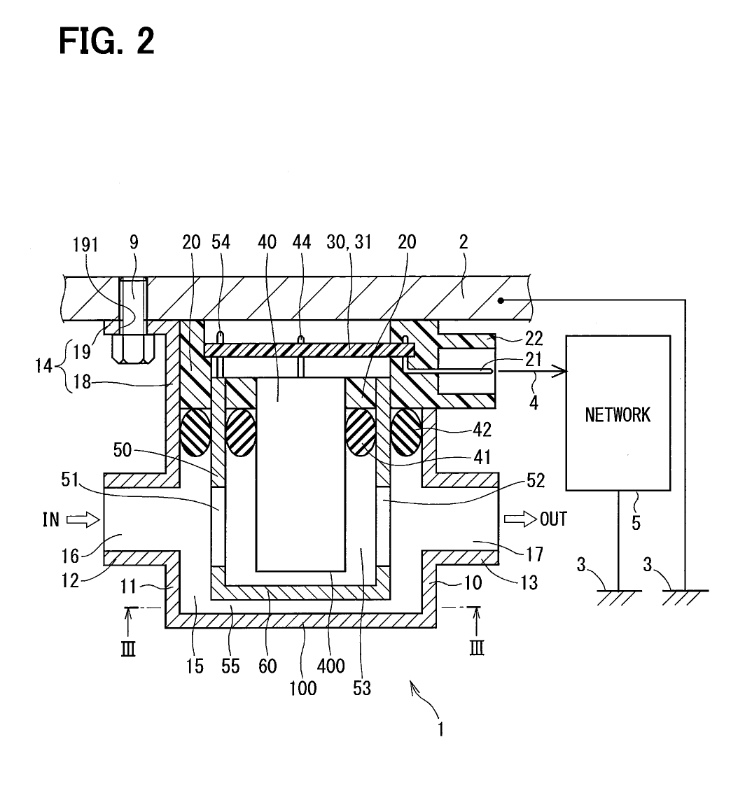

The fuel pipe 10 includes a cup portion 11, a first connection pipe 12, a second connection pipe 13, and a mounting member 14. The cup portion 11 is in a bottomed tubular shape. The first connection pipe 12 and the second connection pipe 13 are connected to the cup portion 11 in a radial direction. The mounting member 14 is equipped to an opening side of the cup portion 11. The fuel pipe 10 is formed of a metallic material such as stainless steel. The first connection pipe 12 and the second connection pipe 13 are connected to a fuel pipe (not shown), which forms a part of the fueling system of the vehicle. The cup portion 11 has an interior defining a fuel chamber 15. The first connection pipe 12 defines a first passage 16 therein. The second connection pipe 13 defines a second passage 17 therein. The fuel chamber 15, the first passage 16, and the second passage 17 communicate with each other. Fuel is enables to flow from the first passage 16 to pass through the fuel chamber 15 and to flow out of the second passage 17. The mounting member 14 includes an accommodating portion 18 and flange portions 19. The accommodating portion 18 is configured to accommodate the affixing member 20. The flange portions 19 are located at an end of the accommodating portion 18. As shown by arrows A and B in FIG. 1, bolts 9 (FIG. 2) are inserted in holes 191, which are formed in the flange portions 19, respectively, and the mounting member 14 is mounted onto a vehicle body 2 via the bolts 9. The vehicle body 2 is electrically connected to a ground 3 of a battery, which is equipped to the vehicle.

The affixing member 20 is in a box shape and is formed of an insulative material such as resin. The affixing member 20 is affixed or fixed to an inside of the accommodating portion 18 of the mounting member 14. A circuit board 31 is equipped inside the affixing member 20. The circuit board 31 is equipped with the detection circuit 30. The affixing member 20 is equipped with a connector 22, which includes a terminal 21. The terminal 21 is connected to the circuit board 31 at one end and is exposed to an interior of the connector 22 at the other end. The terminal 21 of the connector 22 is connectable with a wire harness 4. In FIG. 2, the wire harness 4 is represented with an arrow.

The detection electrode 40 is in a bar shape or in a a bottom tubular shape. The detection electrode 40 is formed of a metallic material such as stainless steel. The detection electrode 40 has an axis, which is perpendicular to a direction of fuel flow inside the fuel chamber 15. The detection electrode 40 has a lower end surface 400, which is located on the side of a bottom portion 100 of the fuel pipe 10. In the present configuration, the lower end surface 400 is opposed to the bottom portion 100 of the fuel pipe 10 and is substantially in parallel with the bottom portion 100. The grounding electrode 50 is in a tubular shape and is formed of a metallic material such as stainless steel. The grounding electrode 50 is located outside the detection electrode 40 and is coaxial with the detection electrode 40. The grounding electrode 50 has a first communication hole 51 and a second communication hole 52. The first communication hole 51 and the second communication hole 52 are in communication with each other in a radial direction of the grounding electrode 50.

The detection electrode 40 and the grounding electrode 50 are affixed to the affixing member 20 at ends on the side of the circuit board 31. The detection electrode 40 and the grounding electrode 50 are, for example, insert-molded to the affixing member 20. With the present configuration, the fuel pipe 10 and the grounding electrode 50 are electrically isolated from each other within the product of the fuel property sensor 1. The detection electrode 40 and the grounding electrode 50 are immersed in fuel, which flows through the fuel chamber 15. Fuel passes through the first communication hole 51 and the second communication hole 52 of the grounding electrode 50. Fuel further passes through a passage 53 formed between the detection electrode 40 and the grounding electrode 50.

The grounding electrode 50 has an axial end relative to the axial direction, and the axial end of the grounding electrode 50 is immersed in fuel. The shield portion 60 extends from the end of the grounding electrode 50 through a space between the bottom portion 100 of the fuel pipe 10 and the lower end surface 400 of the detection electrode 40. The shield portion 60 is substantially in parallel with the direction of flow of fuel in the fuel pipe 10. Therefore, the shield portion 60 is configured not to obstruct the flow of fuel in the fuel chamber 15.

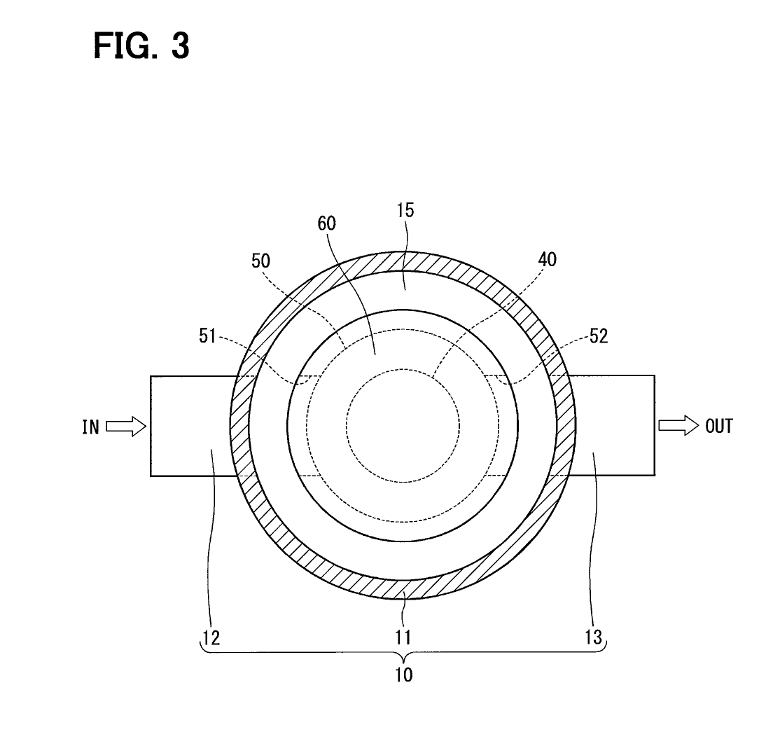

As shown in FIG. 3, the shield portion 60 according to the first embodiment entirely surrounds the axial end of the grounding electrode 50. The shield portion 60 is formed of an electrically conductive material such as stainless steel. The shield portion 60 may be integrally formed with the grounding electrode 50. Alternatively, the shield portion 60 may be formed separately from the grounding electrode 50. In this case, the shield portion 60 may be affixed to the end of the grounding electrode 50 to be electrically conductive with the grounding electrode 50. With the present configuration, the shield portion 60 shields the detection electrode 40 from the fuel pipe 10 thereby to avoid occurrence of capacitive coupling between the detection electrode 40 and the fuel pipe 10.

An O-ring 41 is interposed between the detection electrode 40 and the grounding electrode 50. The O-ring 41 is formed of an elastic member. An O-ring 42 is interposed between the grounding electrode 50 and the fuel pipe 10. The O-ring 42 is formed of an elastic member. The two O-rings 41 and 42 restrict leakage of fuel from the fuel chamber 15 toward the circuit board 31.

The detection electrode 40 and the grounding electrode 50 are connected to the detection circuit 30 through the terminals 44 and 54, respectively. The detection electrode 40 is applied with voltage from the detection circuit 30 through a terminal 44. The grounding electrode 50 is connected with the ground 3 through the terminal 54, the detection circuit 30, the wire harness 4, and the vehicle network 5. The detection electrode 40 and the grounding electrode 50 form a capacitor with fuel, which flows through the passage 53. In the present capacitor, the fuel in the passage 53 forms a dielectric medium. The detection circuit 30 is configured to charge electricity into the capacitor and to discharge electricity from the capacitor. In this way, the detection circuit 30 detects a capacitance between the detection electrode 40 and the grounding electrode 50 according to a specific inductive capacity of fuel, which flows through the passage 53 formed between the detection electrode 40 and the grounding electrode 50. The wire harness 4 is connected to the terminal 21 of the connector 22. The detection circuit 30 transmits a signal, which corresponds to the capacitance, through the wire harness 4 to an electronic control unit (ECU, not shown). The ECU is equipped to a vehicle network 5. The ECU may control operation parameters of the injector, such as a fuel injection quantity, an ignition timing, and/or the like, according to the concentration of ethanol contained in fuel. The concentration of ethanol is based on the capacitance.

Subsequently, consideration of an assumable case will be made. In the assumable case, a disturbance occurs to cause an electromagnetic wave exerting an influence on the wire harness 4, which connects the detection circuit 30 with the vehicle network 5. In an assumable configuration, the shield portion 60 is not equipped to the end of the grounding electrode 50. In the assumable configuration, when an electromagnetic induction noise is induced in the wire harness 4, capacitive coupling occurs between the grounding electrode 50 and the detection electrode 40, and capacitive coupling also occurs between the detection electrode 40 and the fuel pipe 10. Consequently, an alternating current flows through a closed circuit, which is formed among the fuel pipe 10, the vehicle body 2, the ground 3 of the battery, the vehicle network 5, the wire harness 4, the detection circuit 30, the grounding electrode 50, and the detection electrode 40. The alternating current may be assumable to exert an influence on an electric potential of the detection electrode 40, which is detected by the detection circuit 30. Consequently, it is concerned about a large detection error caused by the detection circuit 30.

To the contrary, according to the present embodiment, the shield portion 60 extends from the end of the grounding electrode 50 into the space between the detection electrode 40 and the fuel pipe 10. In the present configuration, the shield portion 60 avoids the capacitive coupling between the detection electrode 40 and the fuel pipe 10. Therefore, even when the wire harness 4 receives an influence of the electromagnetic wave caused by a disturbance, the detection electrode 40 is protected from passage of the alternating current caused by the electromagnetic induction noise. Therefore, the present configuration enables to remove the influence, which is caused by the alternating current and exerted on the detection of the capacitance implemented with the detection circuit 30.

The present embodiment may produce operation effects as follows.

(1) According to the present embodiment, the shield portion 60 is equipped to conduct with the grounding electrode 50. The shield portion 60 avoids the capacitive coupling between the detection electrode 40 and the fuel pipe 10. In this way, the shield portion 60 removes an influence caused by an electromagnetic induction noise. Therefore, the present configuration enables the detection circuit 30 to implement accurate detection. Thus, the present configuration enables to enhance detection accuracy of the fuel property sensor 1.

(2) According to the present embodiment, the fuel pipe 10 is formed of, for example, a metallic material. In the present configuration, the fuel pipe 10 can be mounted onto the vehicle body 2 directly using a fastener such as a bolt. Therefore, the present configuration enables to avoid loosing of the bolt due to, for example, oscillation of the vehicle. In addition, the mounting member may be formed of a metallic material. In this case, strength of the mounting member may be enhanced to oscillation of the vehicle, compared with a configuration formed of a resin or the like.

(3) According to the present embodiment, the fuel pipe 10 can be affixed to the grounding electrode 50 by using the affixing member 20, which is formed of an insulative material such as resin. Therefore, the present configuration enables to reduce a manufacturing cost of the fuel property sensor 1.

(4) According to the present embodiment, the shield portion 60 is substantially in parallel with the direction of flow of fuel in the fuel pipe 10. Therefore, the shield portion 60 is configured not to obstruct the flow of fuel in the fuel chamber 15.

### Second Embodiment

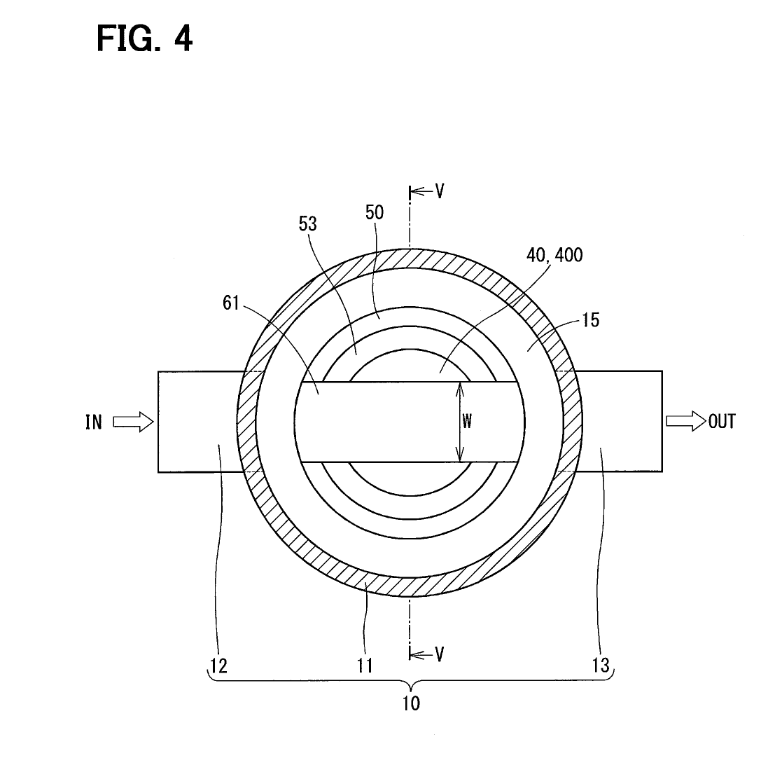

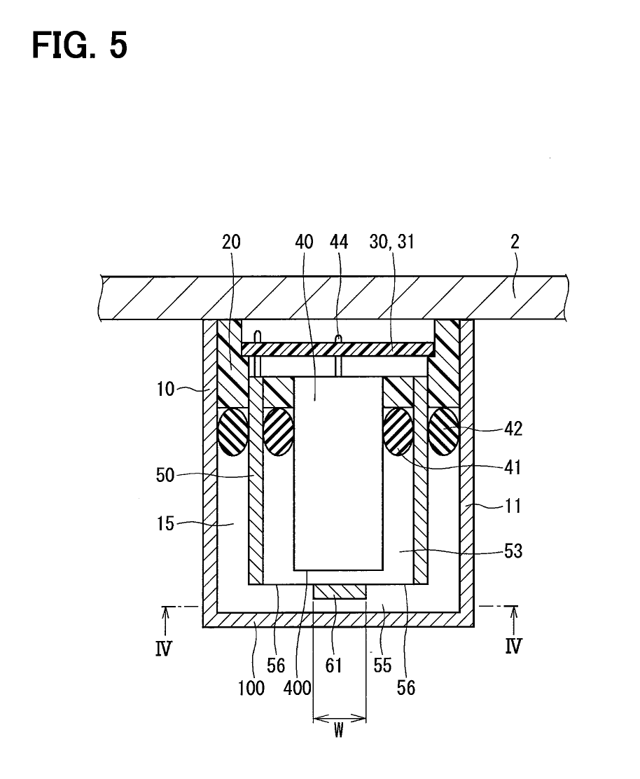

A second embodiment of the present disclosure will be described with reference to FIGS. 4 to 6. FIG. 4 shows a portion of the fuel property sensor 1 according to the second embodiment. The portion of the fuel property sensor 1 shown in FIG. 4 is equivalent to the portion shown in FIG. 3 of first embodiment. FIG. 5 is a sectional view taken along a line V-V in FIG. 4. FIG. 5 shows the fuel property sensor 1 at an angle rotated by 90 degrees around the axis of the electrode relative to FIG. 2 in the first embodiment. In the configuration of FIG. 5, fuel flows in a direction perpendicular to the drawing (plane of paper). In the second embodiment, a shield portion 61 surrounds a part of the end (axial end) of the grounding electrode 50. The shield portion 61 extends along the direction of fuel flow in the fuel chamber 15. The present configuration enables the shield portion 61 not to case large fluid resistance to the fuel flow. The grounding electrode 50 has an end, which is not surrounded by the shield portion 61 partially and opened partially. In the present configuration, an inner circumferential periphery of the grounding electrode 50 and the shield portion 61 form an opening 56 therebetween. In addition, a passage 55 is formed on the side of the bottom portion of the fuel pipe 10, and the passage 53 is formed inside the grounding electrode 50. The present configuration enables fuel to flow through the opening 56 between the passage 55 and the passage 53.

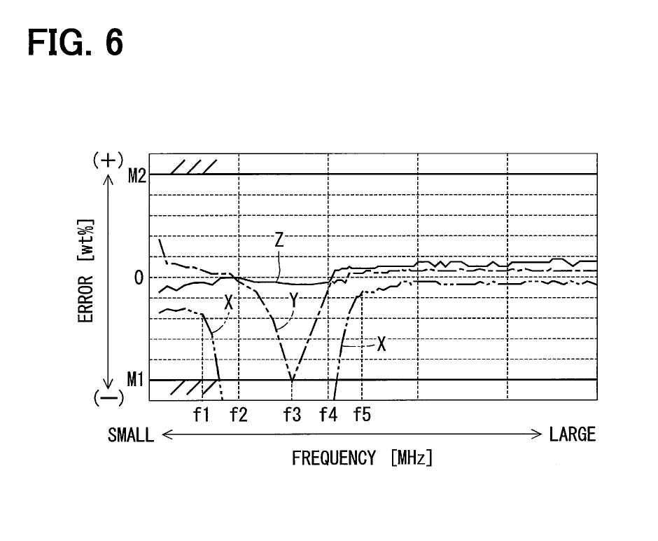

FIG. 6 shows a result of a bulk current injection examination (BCL examination) implemented by applying an electromagnetic wave to the wire harness 4, which is connected to the terminal 21 of the connector 22. The BCL examination is implemented on fuel property sensors having a configuration X, a configuration Y, and a configuration X, respectively. The configuration X is not equipped with the shield portion. The configuration Y includes the shield portion 61. In the configuration Y, the shield portion 61 surrounds 16% or more of a total area of a pipe portion of the grounding electrode 50. In addition, in the configuration Y, the shield portion 61 surrounds 22% or more of a total area of the lower end surface 400 of the detection electrode 40. The configuration Z includes the shield portion 61. In the configuration Z, the shield portion 61 surrounds 46% or more of the total area of the pipe portion of the grounding electrode 50. In addition, in the configuration Z, the shield portion 61 surrounds 66% or more of the total area of the lower end surface 400 of the detection electrode 40. In short, the width W of the shield portion 61 in the configuration Y is smaller than the width W of the shield portion 61 in the configuration Z.

In FIG. 6, a two-point chain line X shows an examination result of the configuration X, a one-point chain line Y shows an examination result of the configuration Y, and a solid line Z shows an examination result of the configuration Z. In the configuration X, an error (concentration error) in the ethanol concentration becomes great relative to the negative direction in the frequency range between f1 and f5. In the configuration Y, the concentration error becomes great relative to the negative direction in the frequency range between f2 and f4. It is noted that, in the configuration Y, the concentration error may become significantly great at the frequency f3 compared with the concentration errors at other frequencies. Nevertheless, the concentration error at the frequency f3 is still within a range defined by a predetermined target value M1, which is required to by a specification a vehicle. In the configuration Z, the concentration errors are small at all frequencies of the electromagnetic waves, which are applied to the wire harness 4 as a disturbance.

According to the above-described examination results, the shield portion 61, which at least partially surrounds the end of the grounding electrode 50, enables to reduce or avoid the capacitive coupling between the detection electrode 40 and the fuel pipe 10. It is noted that the area of the shield portion 61 is not limited to one of the configuration Y and the configuration Z employed in the experiment. The area of the shield portion 61 may be determined arbitrarily according to various conditions, experimental results, and/or the like. For example, the area of the shield portion 61 may be determined arbitrarily according to a characteristic of the capacitive coupling between the detection electrode 40 and the fuel pipe 10. The characteristic of the capacitive coupling may be related to a distance between the bottom portion 100 of the fuel pipe 10 and the detection electrode 40, the diameter of the detection electrode 40, the material of the detection electrode 40, a target value required by a specification of the vehicle, and/or the like.

The present second embodiment may produce operation effects as follows.

(1) According to the second embodiment, the shield portion 61 at least partially surrounds the end of the grounding electrode 50. In this way, the present configuration enables to reduce or avoid the capacitive coupling between the detection electrode 40 and the fuel pipe 10. In addition, the present configuration enables to reduce or avoid pressure loss and/or stagnation caused in fuel, which flows through the fuel pipe 10. Therefore, the fuel property sensor 1 is enabled to react quickly to change in the property of fuel, which flows through the fuel pipe 10. Thus, the present configuration enables to enhance detection response of the fuel property sensor 1.

(2) According to the second embodiment, the shield portion 61 is located around the end of the grounding electrode 50 to extend along the direction of fuel flow in the fuel chamber 15. The present configuration enables the shield portion 61 not to cause a large fluid resistance in the fuel flow through the fuel chamber 15. Therefore, the present configuration enables to enhance detection response of the fuel property sensor 1.

### Third Embodiment

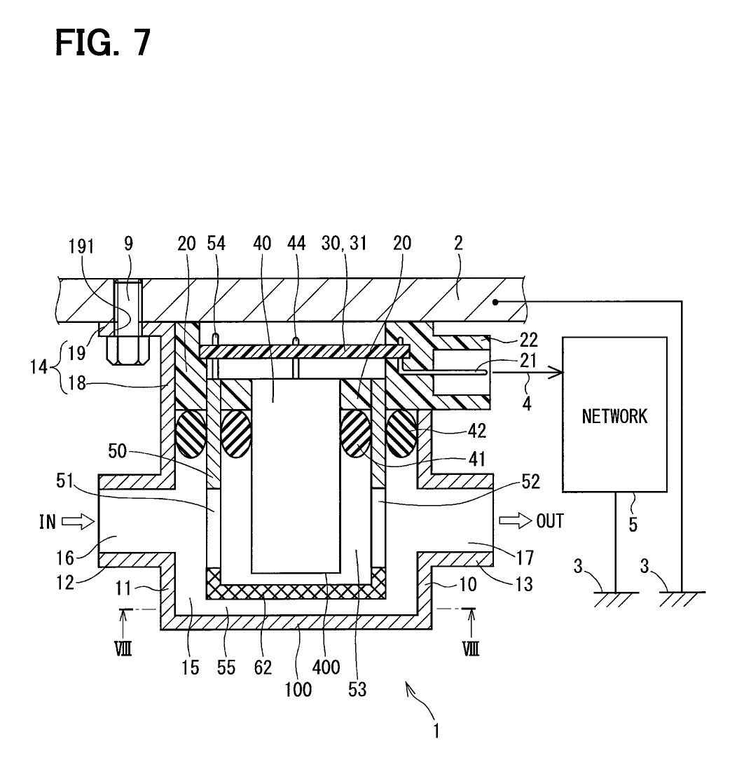

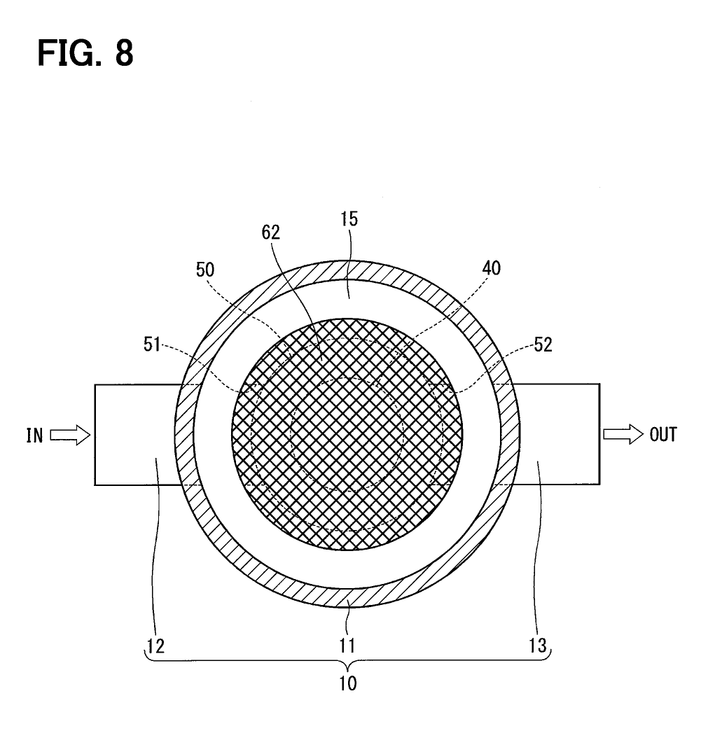

A second embodiment of the present disclosure will be described with reference to FIGS. 7 and 8. According to the present third embodiment, a shield portion 62 is formed of an electrically conductive net. The shield portion 62 entirely surrounds the axial end of the grounding electrode 50, which is located on the end of the grounding electrode 50 in the axial direction. The present configuration enables fuel to flow through apertures formed by a mesh of the net forming the shield portion 62. Thus, the present configuration enables fuel to flow between the passage 55 on the side of the bottom portion of the fuel pipe 10 and the passage 53 inside the grounding electrode 50 through the shield portion 62. Therefore, the fuel property sensor 1 is enabled to react quickly to change in the property of fuel, which flows through the fuel pipe 10. Thus, the present configuration enables to enhance detection response of the fuel property sensor 1.

### Fourth Embodiment

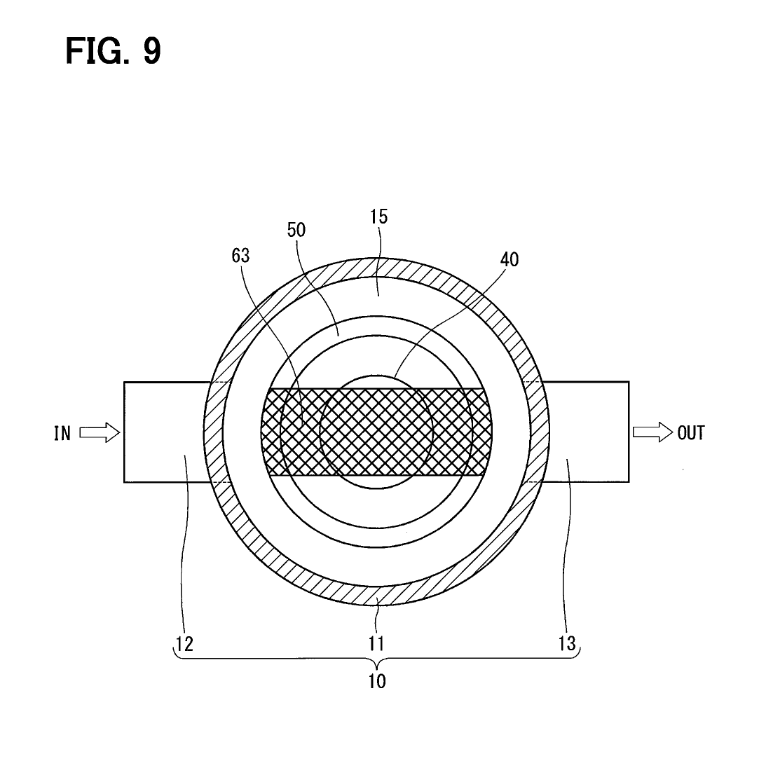

A fourth embodiment of the present disclosure will be described with reference to FIG. 9. According to the present fourth embodiment, a shield portion 63 is formed of an electrically conductive net. The shield portion 63 partially surrounds the grounding electrode 50 in the axial direction. The present configuration enables fuel to flow through apertures formed by a mesh of the net forming the shield portion 63 In addition, the present configuration enables fuel to flow through openings of the grounding electrode 50, which is not surrounded by the shield portion 63. Thus, the present configuration enables fuel to flow between the passage 55 on the side of the bottom portion of the fuel pipe 10 and the passage 53 inside the grounding electrode 50 through the shield portion 63 and the openings. The present configuration according to the fourth embodiment enables further to reduce a fluid resistance and/or stagnation in fuel flow through the fuel pipe 10, compared with the second and third embodiments.

### Other Embodiment

(1) According to the above-described embodiments, the first connection pipe 12 and the second connection pipe 13 of the fuel pipe 10 are connected with the fuel pipe, which is a component of the fueling system of the vehicle. It is noted that, the fuel pipe 10 may be a component forming the fueling system of the vehicle in another embodiment. That is, the fuel pipe, which is a component of the fueling system of the vehicle, may be equipped with the detection electrode and the grounding electrode directly.

(2) According to the above-described embodiments, both the axis of the detection electrode 40 and the axis of the grounding electrode 50 are perpendicular to the direction of the fuel flow in the fuel chamber 15. It is noted that, at least one of the axis of the detection electrode and the axis of the grounding electrode may be in parallel with the direction of the fuel flow in the fuel chamber in another embodiment.

(3) According to above-described embodiments, the detection circuit 30 is configured to charge electricity to and discharge electricity from the capacitor. The capacitor is formed with the detection electrode 40, the grounding electrode 50, and fuel residing between the detection electrode 40 and the grounding electrode 50. In this way, the detection circuit 30 detects the capacitance between the detection electrode 40 and the grounding electrode 50. It is noted that, the detection circuit may be configured to detect an oscillation frequency of the capacitor thereby to detect the capacitance in another embodiment.

(4) According to the above-described embodiments, the shield portion is equipped to pass through the center of the axis of the detection electrode 40. It is noted that, the shield portion may be shifted radially outward from the center of the axis of the detection electrode 40 in another embodiment. In this case, the shield portion may not pass through the center of the axis of the detection electrode 40.

According to the present disclosure, the fuel property sensor includes the detection electrode and the grounding electrode inside the fuel pipe. The fuel pipe is mountable to the vehicle body. The fuel pipe and the grounding electrode are fixed in the state where the fuel pipe and the grounding electrode are electrically isolated from each other. The conductive shield portion extends from the end of the grounding electrode and extends between the detection electrode and the fuel pipe. With the present configuration, the shield portion is enabled to restrict capacitive coupling between the detection electrode and the fuel pipe, even when an electromagnetic induction noise is induced in the wire harness, which is connected to the detection circuit, which detects the capacitance between the electrodes. Therefore, the present configuration enables to restrict the alternating current caused by the electromagnetic induction noise from flowing through the detection electrode. Thus, the present configuration enables to restrict the alternating current from exerting an influence on the capacitance detection of the detection circuit. Therefore, the present configuration enables to enhance the detection accuracy of the fuel property sensor.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A fuel property sensor comprising:
a fuel pipe configured to be mounted to a vehicle body;
a detection electrode configured to be immersed in fuel, which flows through the fuel pipe;
a grounding electrode being in a tubular shape and located outside the detection electrode;
an affixing member configured to affix the fuel pipe and the grounding electrode in a state where the fuel pipe and the grounding electrode are electrically isolated from each other;
a detection circuit configured to detect a capacitance between the detection electrode and the grounding electrode according to a specific inductive capacity of fuel, which flows between the detection electrode and the grounding electrode; and
a shield portion being electrically conductive, the shield portion extending from an end of the grounding electrode and extending between the detection electrode and the fuel pipe, the end of the grounding electrode configured to be immersed in fuel, which flows through the fuel pipe.

2. The fuel property sensor according to claim 1, wherein
the shield portion is electrically conductive with the grounding electrode, and
the shield portion is configured to restrict capacitive coupling between the detection electrode and the fuel pipe.

3. The fuel property sensor according to claim 1, wherein
the fuel pipe defines a fuel chamber therein, and
the shield portion is in parallel with a direction of fuel flow in the fuel chamber.

4. The fuel property sensor according to claim 1, wherein
the shield portion surrounds at least a part of a lower end surface of the detection electrode, and
the shield portion and an inner circumferential periphery of the grounding electrode define an opening therebetween.

5. The fuel property sensor according to claim 4, wherein
the fuel pipe defines a fuel chamber therein, and
the shield portion extends in a direction of fuel flow in the fuel chamber at an end of the grounding electrode.

6. The fuel property sensor according to claim 1, wherein the shield portion is a net configured to pass fuel therethrough.
